(19) United States
(12) Patent Application Publication
(10) Pub. No.: US 2005/0087007 A1
(43) Pub. Date: Apr. 28, 2005

(54) Tire monitor system with spring retention clip

(75) Inventor: Michael A. Uleski, Roseville, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/692,975

(22) Filed: Oct. 24, 2003

(51) Int. Cl. G01M 17/02

(52) U.S. Cl. 73/146

(57) ABSTRACT

A tire monitoring apparatus, for mounting on a vehicle wheel that is configured to have a tire mounted thereon and that has a first opening, includes a tire monitor for monitoring a tire parameter. The tire monitor includes a housing having a second opening. A tire valve stem is configured to extend through the first and second openings, and the valve stem has an aperture. The apparatus further includes a clip that is configured to be inserted into the aperture and engage the housing to attach together the tire monitor and the valve stem.

### BACKGROUND OF THE INVENTION

1. Field of the Invention

The invention relates to an attachment mechanism for a tire monitoring system.

2. Background Art

Tire monitoring systems are designed to monitor a tire parameter, such as tire pressure, and may be configured to be attached to a vehicle wheel. Examples of prior attachment mechanisms for use with tire monitoring systems are disclosed in U.S. Pat. Nos. 5,844,131 and 6,055,855.

### SUMMARY OF THE INVENTION

Under the invention, a tire monitoring apparatus is provided for mounting on a vehicle wheel that is configured to have a tire mounted thereon, wherein the wheel has a first opening. The apparatus includes a tire monitor for monitoring a tire parameter, and the tire monitor includes a housing having a second opening. A tire valve stem is configured to extend through the first and second openings, and the valve stem has an aperture. The apparatus further includes a clip that is configured to be inserted into the aperture and engage the housing to attach together the tire monitor and the valve stem.

Further under the invention, a tire monitoring apparatus is provided for mounting on a vehicle wheel that is configured to have a tire mounted thereon, wherein the wheel has a first opening. The apparatus includes a tire monitor for sensing pressure in the tire. The tire monitor includes a housing having a cylindrical surface and a second opening that extends through the cylindrical surface. A tire inflator valve assembly is configured to extend through the first and second openings, and has a longitudinal axis and first and second ends. The valve assembly further includes a threaded portion disposed proximate the first end, and an aperture disposed proximate the second end. The apparatus further includes a clip having a main body and a cantilevered portion extending from the main body. The cantilevered portion is configured to be inserted into the aperture of the valve assembly such that the cantilevered portion extends generally transverse to the axis of the valve assembly. The main body of the clip has a cylindrical surface that is engageable with the cylindrical surface of the housing of the tire monitor when the cantilevered portion is inserted into the aperture of the valve assembly. A threaded fastener is engageable with the threaded portion of the valve assembly for drawing the main body of the clip against the cylindrical surface of the housing of the tire monitor.

### BRIEF DESCRIPTION OF THE DRAWINGS

FIG. 1 is a cross-sectional view of a tire monitoring apparatus according to the invention mounted on a wheel of a motor vehicle, wherein the apparatus includes a tire monitor attached to a tire inflator valve assembly with a retainer clip;

FIG. 2 is an enlarged cross-sectional view of a portion of a housing of the tire monitor, showing a pocket formed in the housing for receiving the clip;

FIG. 3 is a side view of a valve stem of the valve assembly;

FIG. 4 is a front perspective view of the clip; and

FIG. 5 is a rear perspective view of the clip.

### DETAILED DESCRIPTION OF THE PREFERRED EMBODIMENT(S)

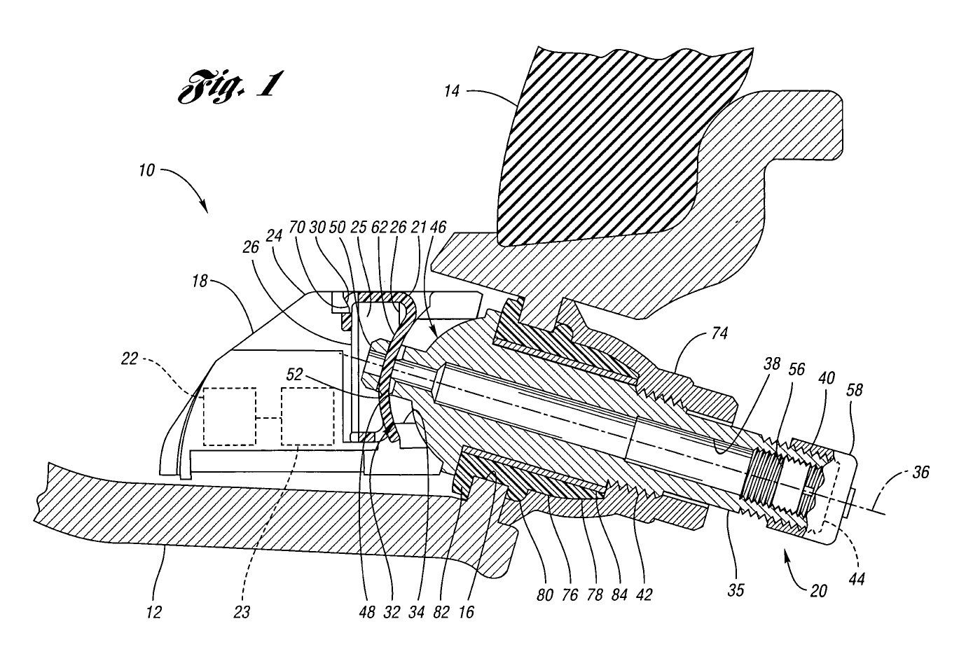

FIG. 1 shows a tire monitoring system or apparatus 10 according to the invention mounted on a vehicle wheel 12 that is configured to have a tire 14 mounted thereon. The apparatus 10 is configured to extend through a first opening 16 in the wheel 12, and includes a tire monitor 18 for monitoring a tire parameter, a tire inflator valve assembly 20 attached to the tire monitor 18, and a retention member or clip 21 for attaching together the tire monitor 18 and the valve assembly 20.

The tire monitor 18 includes one or more monitoring devices, such as one or more sensors 22, for monitoring one or more tire parameters, such as tire pressure, temperature, location, status (i.e., whether or not the tire 14 is in motion) and/or speed. The tire monitor 18 may also include one or more transmitters 23 in communication with the sensors 22 for transmitting data signals representing information concerning the one or more tire parameters to a receiver (not shown). For example, the tire monitor 18 may be configured to sense pressure in the tire 14, and provide a signal that is indicative of the sensed pressure to the receiver. If the air pressure in the tire 14 reduces below a predetermined threshold, the tire monitor 18 may provide a signal to the receiver that actuates an alarm, such as a light on a vehicle instrument panel, to apprise a vehicle occupant of the pressure reduction.

The tire monitor 18 includes a housing 24 for receiving the sensors 22 and/or transmitters 23. The housing 24 defines a pocket 25 for receiving a portion of the valve assembly 20 and the clip 21. Referring to FIGS. 1 and 2, the housing 24 further includes multiple ribs 26 formed in housing side walls that define the pocket 25. The ribs 26 are configured to allow the clip 21 to slide into the pocket 25, while providing an interference fit with the clip 21 to help retain the clip 21 in the pocket 25. In the embodiment shown in FIGS. 1 and 2, each rib 26 has a curved surface 28 that is configured to provide a line of contact between the rib 26 and the clip 21.

The housing 24 may also be provided with a projection, such as tab 30, that is engageable with the clip 21 to further retain the clip 21 in the pocket 25, as explained below in detail. Moreover, in the embodiment shown in FIGS. 1 and 2, the housing 24 includes an engaging surface, such as cylindrical surface 32, and a second opening 34, such as an elongated slot, that extends through the cylindrical surface 32.

As shown in FIG. 1, the valve assembly 20 includes a valve stem 35 having a longitudinal axis 36 and a passage 38 through which air may travel. The valve stem 35 further includes first and second threaded portions 40 and 42, respectively, disposed proximate a first end 44 of the valve stem 35. In addition, the valve stem 35 includes an engaging surface, such as a spherical surface 46, and an aperture 48 proximate a second end 50 of the valve stem 35.

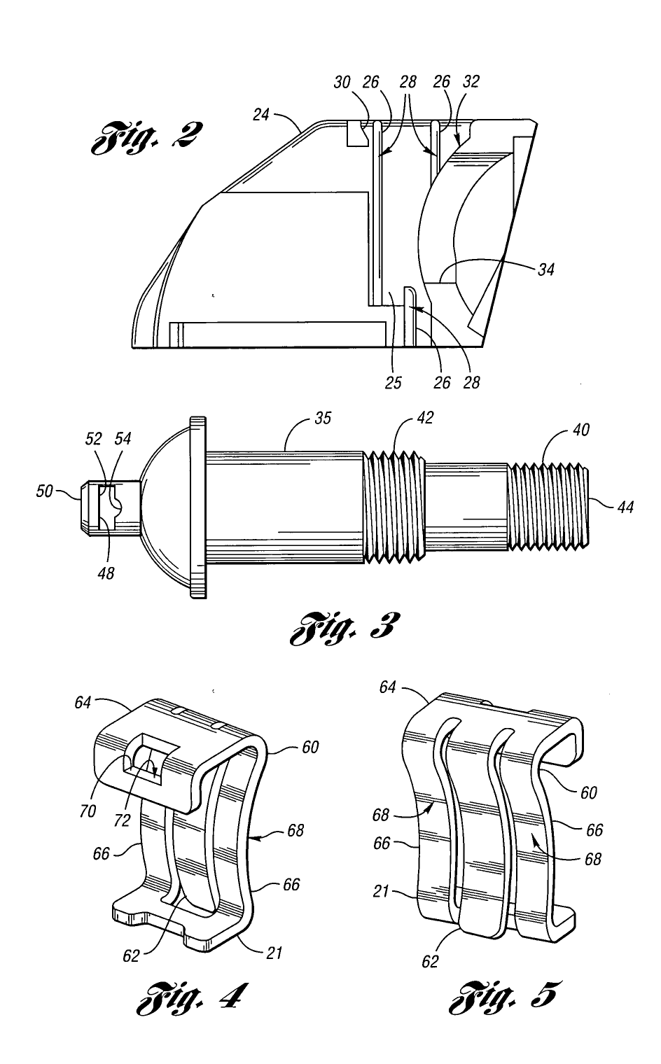

Referring to FIGS. 1 and 3, the aperture 48 includes a first portion 52 configured to receive the clip 21, and a second portion 54 in fluid communication with the passage 38 and configured to allow air to pass around the clip 21 to thereby allow air to travel through the passage 38. While the portions 52 and 54 may have any suitable configuration, in the embodiment shown in FIG. 3, the first portion 52 comprises a generally rectangular slot, and the second portion 54 comprises a curved groove disposed adjacent to the first portion 52.

As shown in FIG. 1, the valve assembly 20 further includes a valve 56 disposed in the passage 38 of the valve stem 35, and a dust cap 58 that is engageable with the first threaded portion 40. The valve 56 is configured to allow air to pass into the tire 14, while inhibiting leakage through the passage 38 from the tire 14.

Referring to FIGS. 1, 4 and 5, the clip 21 is engageable with the housing 24 and the valve stem 35 for securing together the tire monitor 18 and the valve assembly 20. While the clip 21 may have any suitable configuration such that the clip 21 is insertable into the aperture 48 of the valve stem 35, in the embodiment shown in FIGS. 4 and 5, the clip 21 includes a main body 60 and a cantilevered portion 62, such as a spring leaf, that extends from the main body 60 and that is configured to be inserted into the first portion 52 of the aperture 48. More specifically, in the embodiment shown in FIGS. 4 and 5, the cantilevered portion 62 is supported by a top portion 64 of the main body 60, and extends between two outer portions 66 of the main body 60 such that the cantilevered portion 62 forms an inner portion of the clip 21.

When the cantilevered portion 62 is inserted into the aperture 48 of the valve stem 35, the cantilevered portion 62 extends generally transverse to the axis 36 of the valve stem 35. As shown in FIGS. 1, 4 and 5, the cantilevered portion 62 may also have a curved configuration to help retain the cantilevered portion 62 in the aperture 48.

The outer portions 66 of the main body 60 each have an engaging surface, such as a cylindrical surface 68, that is engageable with the cylindrical surface 32 of the housing 24 when the cantilevered portion 62 is inserted into the aperture 48 of the valve stem 35. Alternatively, each outer portion 66 may have any suitable engaging surface that is engageable with the valve stem 35. For example, if the valve stem 35 has a spherical engaging surface, each outer portion 66 may be provided with a complimentary spherical engaging surface.

As shown in FIGS. 1 and 4, the clip 21 may also include an opening, such as a slot 70, for receiving the tab 30 of the housing 24. The tab 30 is engageable with a surface 72 that defines the slot 70 to retain the clip 21 in the pocket 25. Alternatively or supplementally, the clip 21 may include a projection, such as a tab, that is received in an opening, such as a slot, of the housing 24 for retaining the clip 21 in the pocket 25.

While the clip 21 may be made of any suitable material and in any suitable manner, in one embodiment of the invention, the clip 21 is made of stamped metal, such as spring steel.

Referring to FIG. 1, the apparatus 10 may further include an additional fastener, such as threaded nut 74, that is engageable with the second threaded portion 42 of the valve stem 35 and the wheel 12. In the embodiment shown in FIG. 1, the nut 74 functions to secure the valve stem 35 to the wheel 12. The nut 74 also functions to draw the valve stem 35 against the cantilevered portion 62 of the clip 21, and to draw the main body 60 of the clip 21 against the cylindrical surface 32 of the housing 24.

A seal 76 may also be positioned between the wheel 12 and the valve stem 35 to inhibit passage of air around the valve stem 35. While the seal 76 may have any suitable configuration, in the embodiment shown in FIG. 1, the seal 76 includes a seal body 78 having first and second flange portions 80 and 82, respectively, and a sleeve portion 84 attached to the seal body 78 for facilitating insertion and removal of the valve stem 35. Furthermore, the seal body 78 and sleeve portion 84 may each be made of any suitable material. For example, the seal body 78 may comprise a rubber material, while the sleeve portion 84 may comprise plastic or metal. Additional details of the seal 76 may be found in co-pending application Ser. No. ______ (attorney docket no. LEAR 04120 PUS), which is hereby incorporated by reference in its entirety.

The apparatus 10 may be assembled together and mounted on the wheel 12 in any suitable manner. For example, referring to FIGS. 1-4, the second end 50 of the valve stem 35 may be inserted through the second opening 34 of the housing 24 of the tire monitor 18, and the clip 21 may be inserted into the pocket 25 such that the cantilevered portion 62 extends into the aperture 48 of the valve stem 35. Furthermore, when the clip 21 is fully seated in the pocket 25, the tab 30 of the housing 24 engages the aperture 70 of the clip 21 to retain the clip in the pocket 25.

Next, the seal 76 may be inserted into the first opening 16 of the wheel 12 such that the wheel extends between the flange portions 80 and 82. The first end 44 of the valve stem 35 may then be inserted through the seal 76 such that the first and second threaded portions 40 and 42, respectively, extend beyond an exterior surface of the wheel 12. The sleeve portion 84 preferably facilitates sliding movement of the valve stem 35 relative to the seal 76.

Advantageously, the angular orientation of the valve stem 35 may be adjusted with respect to the housing 24 so that the valve assembly 20 and housing 24 may conform to various wheel configurations. For example, the valve stem 35 may be pivoted with respect to the housing 24 such that the first end 44 of the valve stem 35 disposed outside of the wheel 12 may move upwardly or downwardly with respect to the position shown in FIG. 1. Once a desired orientation is achieved, the nut 74 may then be threaded onto the second threaded portion 42 of the valve stem 35 to secure the tire monitor 18 and valve assembly 20 to the wheel 12.

With the configuration described above, the tire monitor 18 may be attached to the valve assembly 20 by sliding the clip 21 into the pocket 25, without requiring rotation of the clip 21 or valve stem 35. As a result, the apparatus 10 may be assembled quickly, while still providing adjustability to conform to various wheel configurations.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A tire monitoring apparatus for mounting on a vehicle wheel that is configured to have a tire mounted thereon, the wheel having an opening, the apparatus comprising:
a tire monitor for sensing a tire parameter, the tire monitor including a housing having an opening;
a tire valve stem that is configured to extend through the opening in the wheel and the opening in the housing, the valve stem having an aperture; and
a clip that is configured to be inserted into the aperture and engage the housing to attach together the tire monitor and the valve stem.

2. The apparatus of claim 1 wherein the aperture includes first and second portions, the first portion being configured to receive the clip, and the second portion being configured to allow air to pass around the clip to thereby allow air to travel through the valve stem.

3. The apparatus of claim 2 wherein the first portion of the aperture comprises a generally rectangular slot, and the second portion of the aperture comprises a groove disposed adjacent to the slot.

4. The apparatus of claim 1 wherein the clip comprises a top portion and a cantilevered portion extending from the top portion, the cantilevered portion being configured to extend into the aperture of the valve stem.

5. The apparatus of claim 4 wherein the cantilevered portion comprises a curved section that is configured to extend into the aperture of the valve stem.

6. The apparatus of claim 1 wherein the clip includes an opening, and the housing of the tire monitor includes a tab that extends into the opening of the clip when the clip is inserted into the aperture of the valve stem.

7. The apparatus of claim 1 wherein the housing of the tire monitor comprises a cylindrical surface, and the clip comprises a cylindrical surface that is engageable with the cylindrical surface of the housing when the clip is inserted into the aperture of the valve stem.

8. The apparatus of claim 1 wherein the housing of the tire monitor includes a pocket for receiving the clip and multiple ribs that are configured to allow the clip to slide into the pocket.

9. The apparatus of claim 8 wherein each rib comprises a curved surface that is configured to provide a line of contact between the rib and the clip.

10. The apparatus of claim 1 wherein the clip comprises two outer portions and an inner portion spaced away from the outer portions, the inner portion being configured to be inserted into the aperture of the valve stem, and the outer portions being configured to engage the housing of the tire monitor when the inner portion is inserted into the aperture of the valve stem.

11. The apparatus of claim 1 wherein the valve stem includes a threaded portion, and the apparatus further comprises a threaded fastener that is engageable with the threaded portion of the valve stem and the wheel to thereby draw the clip against the housing of the tire monitor.

12. A tire monitoring apparatus for mounting on a vehicle wheel that is configured to have a tire mounted thereon, the wheel having an opening, the apparatus comprising:
a tire monitor for sensing pressure in the tire, the tire monitor having a housing with a cylindrical surface, the housing further having an opening that extends through the cylindrical surface;
a tire inflator valve assembly that is configured to extend through the opening in the wheel and the opening in the housing, the valve assembly having a longitudinal axis and first and second ends, the valve assembly further having a threaded portion disposed proximate the first end, and an aperture disposed proximate the second end;
a clip having a main body and a cantilevered portion extending from the main body, the cantilevered portion being configured to be inserted into the aperture of the valve assembly such that the cantilevered portion extends generally transverse to the axis of the valve assembly, the main body having a cylindrical surface that is engageable with the cylindrical surface of the housing of the tire monitor when the cantilevered portion is inserted into the aperture of the valve assembly; and
a threaded fastener that is engageable with the threaded portion of the valve assembly for drawing the main body of the clip against the cylindrical surface of the housing of the tire monitor.

13. The apparatus of claim 1 wherein the housing has a pocket for receiving the clip, and the clip is insertable into the pocket after the valve stem has been inserted through the opening of the housing.

14. The apparatus of claim 1 wherein the valve stem has a longitudinal axis, and the clip has a cantilevered portion that is configured to be inserted into the aperture of the valve stem such that the cantilevered portion extends generally transverse to the axis of the valve stem.

15. The apparatus of claim 1 wherein the clip includes one of a tab and a tab-receiving opening, and the housing of the tire monitor includes the other of the tab and the tab-receiving opening, and wherein the tab is configured to extend into the tab-receiving opening when the clip is inserted into the aperture of the valve stem to retain the clip in the aperture.

16. The apparatus of claim 12 wherein the aperture of the valve assembly includes first and second portions, the first portion being configured to receive the cantilevered portion of the clip, and the second portion being configured to allow air to pass around the cantilevered portion of the clip to thereby allow air to travel through the valve assembly.

17. The apparatus of claim 16 wherein the first portion of the aperture comprises a generally rectangular slot, and the second portion of the aperture comprises a groove disposed adjacent to the slot.

18. The apparatus of claim 12 wherein the main body of the clip includes an opening, and the housing of the tire monitor includes a tab that extends into the opening of the main body when the cantilevered portion of the clip is inserted into the aperture of the valve assembly.

19. The apparatus of claim 12 wherein the housing of the tire monitor includes a pocket for receiving the clip and multiple ribs that are configured to allow the clip to slide into the pocket.

20. The apparatus of claim 19 wherein each rib comprises a curved surface that is configured to provide a line of contact between the rib and the clip.
